(19) United States
(12) Patent Application Publication
(10) Pub. No.: US 2004/0128344 A1
(43) Pub. Date: Jul. 1, 2004

(54) Content and service registration, query and subscription, and notification in networks

(75) Inventor: Dirk Trossen, Cambridge, MA (US)

Correspondence Address: BANNER & WITCOFF, 1001 G STREET N W, SUITE 1100, WASHINGTON, DC, 20001, US

(73) Assignee: Nokia Corporation, ESPOO (FI)

(21) Appl. No.: 10/330,146

(22) Filed: Dec. 30, 2002

(51) Int. Cl. G06F 15/16

(52) U.S. Cl. 709/203; 709/227

(57) ABSTRACT

Systems and methods are provided for registering content and services available within a network, as well as for querying and subscribing to notifications of particular events, such as events related to content and services registered within the network. Systems and methods are also provided for subscribing to changes to the registration and de-registration states of content and/or service(s), as well as for subscriptions to events related to requests for content and/or services. In some embodiments, the systems and methods of the present invention operate within a SIP infrastructure. According to some embodiments, SIP event packages are employed within a SIP infrastructure.

### FIELD OF THE INVENTION

This invention relates generally to telecommunications networks. More particularly, the invention concerns systems and methods for content and service registration, query and subscription, and notification in networks.

### BACKGROUND OF THE INVENTION

In a network environment, it is often important for devices to discover available services in the network and to learn information about the configuration of those services. Service discovery, therefore, has been a topic for research and standardization for several years. As a result, protocols and products have been developed to allow for registration and discovery of services. Examples include the Internet protocol known as Service Location Protocol (SLP), JINI™ (a set of JAVA® application program interfaces (APIs) that enable a device to announce itself on a network and to provide some details about its capabilities), and the networking architecture known as Universal Plug and Play (UPnP). These protocols and products, however, do not typically provide for the discovery of content available in respective networks.

One of the common architectural foundations for service discovery solutions is the existence of a service discovery agent (service agent), such as described in the Internet Engineering Task Force (IETF) document RFC 2608, “Service Location Protocol, Version 2, June 1999.” These agents typically serve a logical, administrative domain in which services subscribe with such agents to offer functionality to other entities. Services can be requested, i.e. discovered, by sending an appropriate request to a service agent that matches the requirements of the request against its repository of internal service subscription data. Although this general architecture may be common, particular embodiments differ in important details such as protocol messages, representation format for services, and objectives with respect to the particular environment. Accordingly, dedicated protocol stacks must be present for each different embodiment.

Multicast-based solutions, such as JINI™ and UPnP, or multicast mode versions of SLP, seek to avoid the existence of a centralized service agent. However, these solutions also suffer from certain drawbacks. For example, such multi-cast solutions generally require specific delivery paradigms. Additionally, they are typically inefficient due to flooding of service requests, hence their applicability is restricted to particular scenarios.

On a related topic, calling models such as Session Initiation Protocol (SIP) and ITU H.323 multimedia conferencing standard provide application layer signaling protocols related to multimedia sessions (see e.g. IETF document RFC 3261, “SIP: Session Initiation Protocol,” July 2002). SIP was generally developed to allow for initiating a session between two or more endpoints in the Internet by making these endpoints aware of the session semantics. Accordingly, devices (or users that run certain applications on these devices) are registered with the SIP backbone so that an invitation to a particular session can be correctly delivered to these endpoints. To achieve this, SIP provides a registration mechanism for devices and users, and it applies mechanisms such as location servers and registrars to route the session invitations appropriately. SIP currently provides methods for discovering certain capabilities for known endpoints (i.e., OPTIONS method for querying a server as to its capabilities for a user); however, this does not apply to unknown endpoints.

Methods have been proposed for integrating service registration and discovery with device registration, such as in a SIP environment. However, such methods generally require extensions to standards for device registration, as well as to products using such device registration standards. Further, such methods do not provide for notifications to be sent to subscribed users in the case that new services become available. They also do not provide for tracking changing availability or de-registration of desired services/content.

Event registration and trigger notification have been proposed as an extension of SIP (see e.g., IETF document RFC 3265, “SIP-Specific Event Notification,” July 2002). Such a proposal, however, does neither specify the semantics of specific events, nor systems and methods for uploading event information. Further, such a proposal does not specifically address systems and methods for tracking changes in the registration and de-registration of services and/or content. Additionally, such a proposal does not address systems and methods for requesting (and removing a request) for notification of service and/or content requests (i.e. report of service/content requests from other devices or entities).

Uploading SIP event information has been addressed in “SIMPLE Presence Publication Mechanism”, Work In Progress, IETF Draft, October 2002. However, the mechanism aims at publishing presence information rather than specifically addressing registration of service/content information. Further, it leaves the handling of the uploaded information to the implementation of the presence server, i.e., it does not enforce a certain usage of the uploaded information.

Thus, a need exists for systems and methods that permit substantially uniform registration of content and services between different discovery protocols, as well as for the substantially uniform querying of contents and services. Further, a need exists for systems and methods that provide for tracking of changing registration and de-registration of desired services and/or contents. Additionally, a need exists for systems and methods that provide for requesting, un-requesting, and notifying of service and/or content requests.

### SUMMARY OF THE INVENTION

In order to overcome the above-described problems and other problems that will become apparent when reading this specification, the present invention provides systems and methods for registering content and services available within a network.

It further provides systems and methods for querying and subscribing to notifications of particular events, such as events related to content and services registered within the network. The present invention also provides systems and methods for subscribing to changes to the registration and de-registration states of content and/or service(s), as well as for subscriptions to events related to requests for content and/or services. Such systems and methods of the present invention may be used with a wide variety of service discovery protocols, systems, and entities.

In some embodiments, the systems and methods of the present invention operate within a SIP infrastructure. According to some embodiments, SIP event packages are employed within a SIP infrastructure. In other embodiments of the invention, computer-executable instructions for implementing the disclosed methods are stored on computer-readable media. Other features and advantages of the invention will become apparent with reference to the following detailed description and figures.

### BRIEF DESCRIPTION OF THE DRAWINGS

The invention will be described in detail in the following description of preferred embodiments with reference to the following figures wherein:

FIG. 1 shows an architecture that supports registration, querying, subscription, and notification methods according to illustrative embodiments of the invention;

FIG. 2 shows a functional diagram of a mobile device acting as the requester of FIG. 1;

FIG. 3 shows a functional diagram of a server, which is representative of the SIP event server and the local repository/service agent of FIG. 1;

FIG. 4 shows message flows between entities of FIG. 1 for a service and/or content registration method according to an illustrative embodiment of the invention;

FIG. 5 shows a SIP REGISTER or SIP PUBLISH message according to the embodiment of FIG. 4;

FIG. 6 shows a SIP REGISTER or SIP PUBLISH message according to a further illustrative embodiment of the invention;

FIG. 7 shows message flows between entities of FIG. 1 for methods of subscription/notification of service and/or content according to another illustrative embodiment of the invention; and

FIG. 8 shows message flows between entities of FIG. 1 for methods of subscription/notification of service and/or content requests according to another illustrative embodiment of the invention.

### DETAILED DESCRIPTION OF THE INVENTION

In the following description of the various embodiments, reference is made to the accompanying drawings that form a part hereof, and in which is shown by way of illustration various embodiments in which the invention may be practiced. It is to be understood that other embodiments may be utilized and structural and functional modifications may be made without departing from the scope of the present invention.

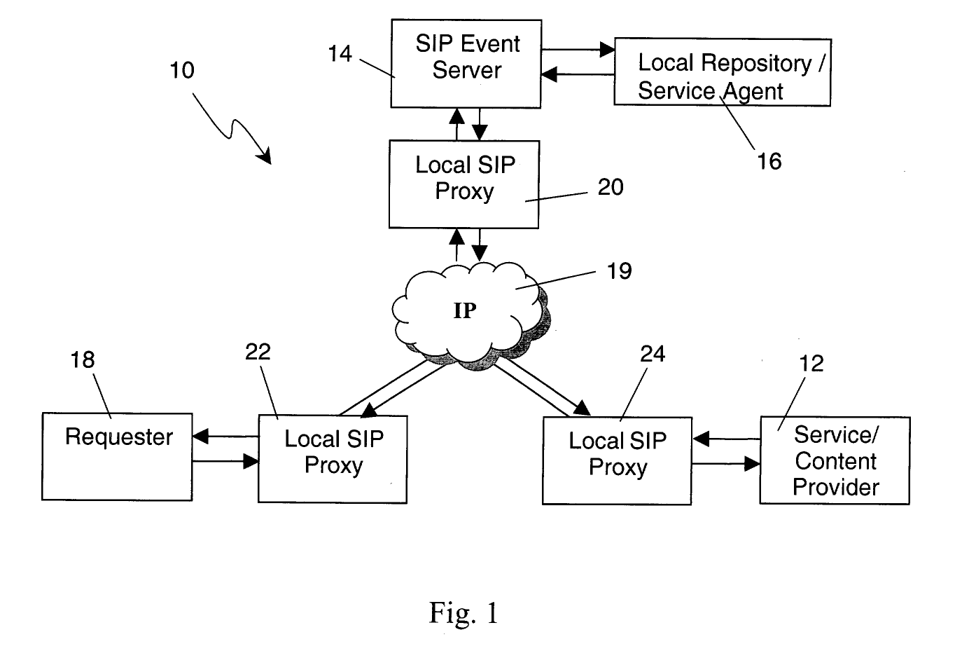

Referring now to FIG. 1, a general architecture 10 is shown that supports content and service registration, query, subscription, and notification in networks. The architecture 10 generally includes a service/content provider 12, a SIP event server 14, a requester 18, and an IP communications network 19 through which provider 12, server 14 and requester 16 communicate.

Service/content provider 12 may include a mobile device or other devices having service and/or content capabilities, such as being able to support multimedia sessions of various parameters. Requester 18 may be any device or entity that requests service and/or content information related to one or more service/content providers. SIP event server 14 is in communication with one or more local repositories 16, which each maintain a database of service and/or content subscriptions. Although shown as a one-to-one relationship, multiple local repositories 16 may be in communication with SIP event server 14. Further, local repository 16 may be in communication with multiple SIP event servers 14. Service/content provider 12 is registered with one or more local repositories 16 via SIP event server 14 for providing service/content communications to requester(s), such as requester 18. Each local repository 16 may include a local service discovery agent 16 (service agent) that operates and maintains repository 16 for storing service/content information about service/content providers within a particular domain.

Architecture 10 provides a session initiation protocol (SIP) framework. As such, service/content provider 12, event server 14, and requester 18 are each registered with a corresponding local SIP proxy, 20, 22 and 24 respectively. Although shown as separate logical entities, SIP event server 14, local repository 16, and/or SIP proxy 20 may be co-located. However, SIP event server 14 is generally an entity that is logically separate from a SIP proxy, and which performs service/content discovery using a protocol that can interact with various discovery protocols. As such, event server 14 acts as an intermediary between requester 18 or service/content provider 12, and local repository/service agent 16. Based on architecture 10, methods of service and/or content registration, query, subscription and notification according to the present invention may be practiced.

In general, architecture 10 provides a common framework through which different service and/or content discovery systems may be integrated. As such, an end-user may transparently access several different types of service and/or content discovery systems. For example, local repository 16 may operate as part of a service discovery system, such as a system using Service Location Protocol (SLP) or JINI™. Without knowing the type of discovery system used with local repository 16, requester 18 may nonetheless discover an entity registered with local repository 16 that offers a desired service and/or content. Further, necessary parameters for the service/content may also be discovered with the same common discovery mechanism. Hence, the methods in this invention allow for integrating disparate discovery systems into a common discovery mechanism. These are discussed in more detail below.

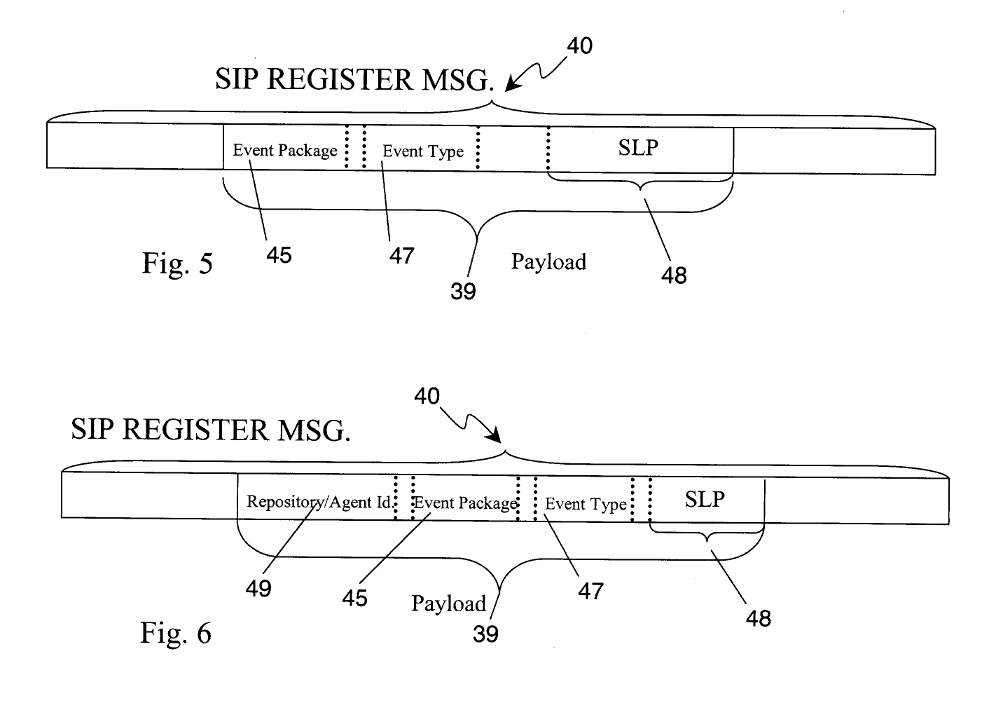

Using architecture 10 as an example framework, a method for service and/or content registration according to one embodiment of the invention generally includes service/content provider 12 registering with SIP event server 14 using a SIP REGISTER message 40 (shown in FIG. 5). SIP REGISTER messages 40 are generally used for registering a device with a SIP proxy. However, SIP REGISTER messages 40 may be used for registering service and/or content of a device or entity with a SIP event server. Accordingly, the SIP REGISTER message 40 includes service and/or content information about service/content provider 12 in the form of a payload 39 in the REGISTER message 40. SIP The message further contains information regarding the event package and event type, in accordance to IETF document RFC 3265, “SIP-Specific Event Notification”, July 2002. The event package indicates that service or content registration is desired, e.g., through event package name “service” or “content”. The event type, e.g., “register”, indicates the action to be taken, i.e., registration of the service. However, it is also possible that the event package and event type information is extracted from the REGISTER message without being explicitly given in the message. The event package information can, for instance, be obtained through recognizing whether the payload 48 specifies a service or a content. Further, if the SIP REGISTER message registers the device, the event type “register” can be assumed, while a de-registration of the device, in accordance to IETF Document RFC 3261, could assume a de-registration of the service/content as well. SIP event server 14 in turn registers the service/content capabilities of service/content provider 12 with local repository 16. As another embodiment, the SIP PUBLISH message can be used to register service/content capabilities with the SIP event server 14.

A method for service discovery according to one embodiment of the invention includes a requester 18 querying the SIP event server for service/content capabilities. Upon reception of the query, SIP event server 14 queries local repository 16 for such information and the requested information is returned to requester 18.

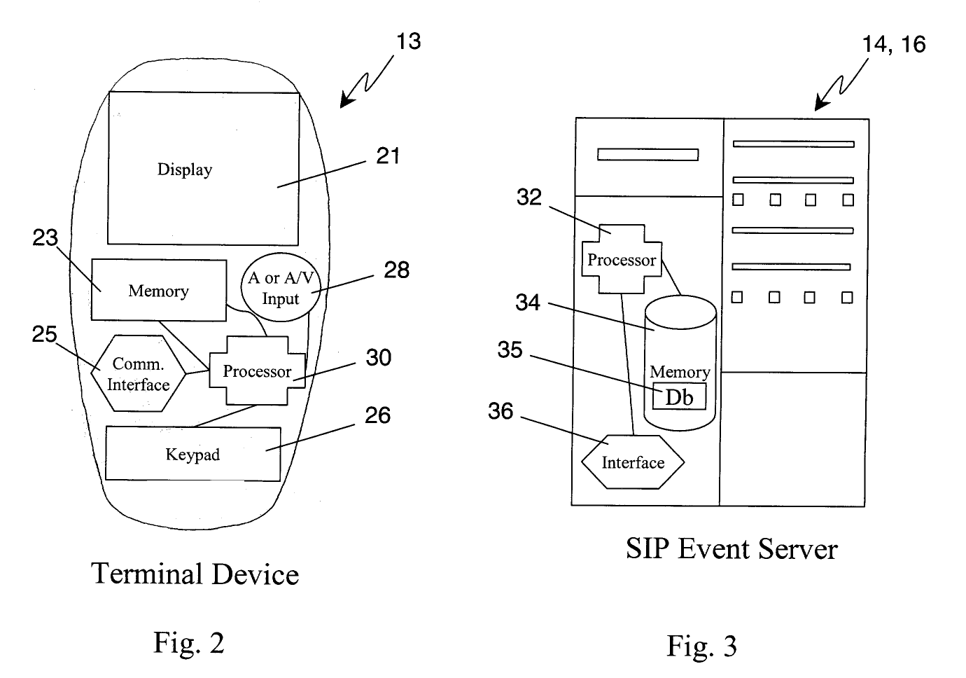

Referring now to FIG. 2, a functional diagram of a mobile device 13 is shown that may act as either a service/content provider 12, a SIP Event Server, or a requester 18 according to embodiments of the invention. The mobile device 13 generally includes a processor 30 connected to a display 21, a memory 23, a communication interface 25, a keypad 26, and an audio or audio/visual input 28. Stored within the memory 23 are instructions for creating messages related to the present invention, such as REGISTER, PUBLISH, or SUBSCRIBE messages, which are described later. The mobile device 13 may comprise a mobile telephone, personal digital assistant (PDA), IP-enabled display device, or other electronic device.

Referring now to FIG. 3, a functional diagram of an entity that may act as SIP event server 14 or a local repository/service agent 16 is shown. Although shown as separate entities, in some embodiments, a single entity may support a logically separate, but co-located, SIP event server 14 with a local repository/service agent 16. Entities 14, 16 generally includes a processor 32 connected to memory 34 and interface 36. Memory 34 contains instructions for processor 32 to perform steps associated with service and/or content registration, discovery, and notification. Further, as a service agent, memory 34 may store a database 35 containing service and/or content registration information for devices or URIs. Additionally, as a SIP event server, memory 34 may store a local database 35 containing subscription information for devices or URIs.

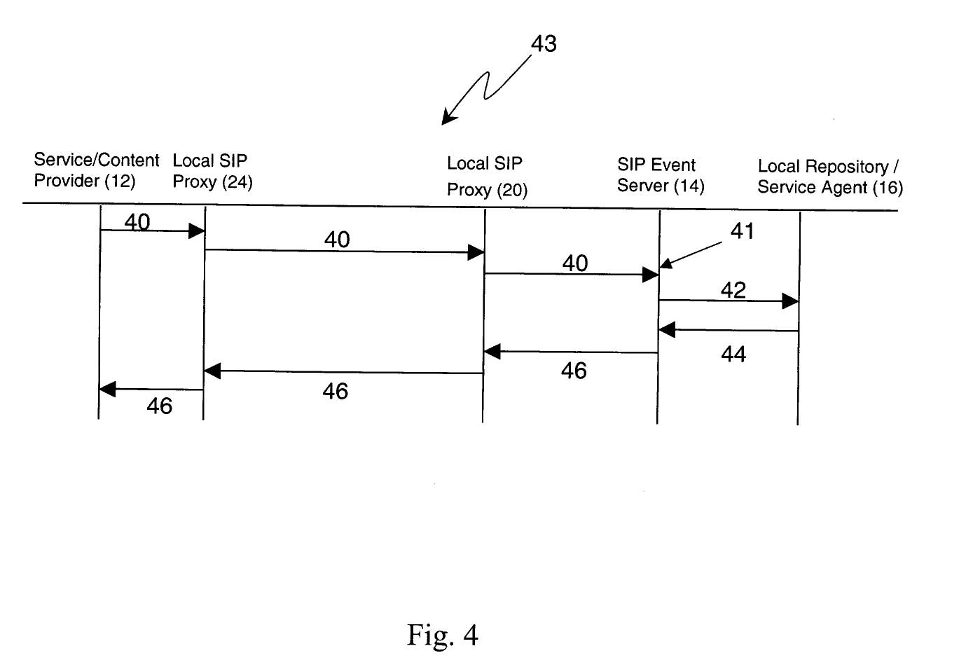

Referring now to FIG. 4 in particular, as well as FIGS. 1-3 in general, message flows for a service and/or content registration method 43 according to the present invention are shown. As an example for use throughout the specification, suppose that service provider 12 is an IP-enabled display device, such as a teleconference unit for a particular company. Suppose further that local repository/service agent 16 is a SLP-based service discovery agent for a facility of the company and that it is a part of the company's private network (not shown). Suppose also that SIP event server 14 is also located within the company's private network.

Registration of display device 12 occurs with display device 12 sending a SIP REGISTER message 40 to SIP event server 14 for registering its service capabilities.

Note that although the present example concerns service capabilities, registration of content is equally applicable, such as content stored and available for distribution from the registering device. Note further that although shown as a SIP REGISTER message, as applicable, message 40 may also be a SIP PUBLISH message in accordance with extensions to SIP (see e.g. SIMPLE Presence Publication Mechanism, draft-olson-simple-publish-01, IETF draft Oct. 24, 2002). In accordance with the SIP infrastructure of architecture 10, display device 12 sends SIP REGISTER message 40, which specifies the URI of the SIP event server 14 as the receiver of the registration, to its corresponding SIP proxy 24. SIP proxy 24 forwards it to SIP proxy 20, which in turn forwards it to SIP event server 14 via IP network 19.

A portion 48 of the payload 39 of REGISTER message 40 shown in FIG. 5 carries a description of services provided by display device 12. This description is not restricted to a single service description if display device 12 is providing several services. The description further contains the URI of the service provider 12 for actual service provisioning. The format of portion 48 of the payload 39 may be an attribute-based format, such as those used with Service Location Protocol (SLP) (see Internet Engineering Task Force (IETF) document Request For Comment (RFC) 2608, “Service Location Protocol,” version 2, June 1999) or Resource Description Framework (RDF) (see “Resource Description Framework Model and Syntax Specific,” W3C Recommendation, 22 Feb. 1999). Further, a dedicated format for SIP service descriptions may be used. A dedicated format, however, would require standardization in appropriate standardization bodies, such as Internet Engineering Task Force (IETF). According to the display device example, the format would likely be an SLP format to match local repository/service agent 16; although, other formats may alternatively be used.

The payload 39 might further include indications 45, 47 (see FIG. 5) of event package and event type, respectively. According to an embodiment of the invention, there are two event packages, namely service packages and content packages. Additionally, there are four event types, namely published or registered, de-registered, requested and request_removed. Using REGISTER message 40, service(s) and/or content may be registered or de-registered as indicated in the payload. The event types of “requested” and “request_removed” will be discussed further below; however, they are related to subscriptions associated to requests for services and/or content. As discussed above, the event packages and event types might also be given implicitly through portion 48 of the payload, i.e., the indications 45 and 47 are not explicitly given in the SIP REGISTER message 40. Defining these event packages and event types according to this embodiment does not extend the SIP core protocol, rather it defines event packages compliant to IETF document RFC 3265, “SIP-Specific Event Notification”, July 2002. Hence, implementation of such event packages may be done on the application level. Accordingly, SIP event server 14 represents a SIP user agent that may interpret event messages according to its programming.

Multiple packages and types and may be registered and/or de-registered with event server 14 according to the payload of REGISTER message 40. Optionally, REGISTER message 40 may be mapped to indicated event package and type; however, such mapping would require standardization in appropriate standardization bodies, such as IETF. In an optional embodiment, SIP REGISTER message 40 contains an “expires” value (not shown) for indicating the length of the registration. Upon expiration of the “expires” value, de-registration may be automatic absent re-registration by service/content provider 16. Further, a default expires value may be set in SIP event server 14 as desired.

Upon reception of REGISTER message 40, SIP event server 14 registers or de-registers (indicated by the event type information in REGISTER message, see FIG. 5) the given service description(s) for the service/content provider 12 by storing 41 such information in database 35 in memory 34 shown in FIG. 3. Further, SIP event server 14 forms a service registration or de-registration message 42 for service provider 12 and sends it to local repository/service agent 16, which acts to register or de-register service/content provider 12 with local repository/service agent 16. Service registration message 42 is formatted to be appropriate for the local repository/service agent 16 to which it is being sent. For example, it may have one format for an SLP-based service agent and another format for an RDF-based service agent. Accordingly, SIP event server 14 formats service registration message 42 to meet the protocol appropriate for local repository/service agent 16, as well as other requirements specific to local repository/service agent 16.

Use of a common message framework, such as SIP, provides advantages over specialized service discovery procedures. For example, service/content provider 12 may create a REGISTER message according to a common SIP format without knowledge of specific requirements related to local repository/service agent 16, and yet service capabilities for service/content provider 12 may be registered with local repository/service agent 16. Further, beyond creation of the payload 39 in SIP REGISTER message 40 (see FIG. 5), registration of its service capabilities may be transparent to service/content provider 12.

Mapping of the REGISTER message 40 and the addition of an identifier 49, as shown in FIG. 6, to identify the local repository/service agent 16 in the REGISTER message may be appropriate for interpretation or forwarding of service information by SIP event server 14. This may also be done implicitly through SIP event server 14 recognizing the payload format (e.g., SLP, RDP) and making a forwarding decision based on the format. Further, SIP event server 14 may also register the service with all associated local repository/service agents by sending a service registration message 42 in a respective format to each local repository/service agent, which may require an appropriate mapping of the service description format as outlined above for the SIP REGISTER message 40. If the local repository/service agent 16 is co-located with SIP event server 14, message 42 may not need to be sent. Instead, the SIP event server 14 implements appropriate local repository/service agent functionality.

As an example, the payload of REGISTER message 40 shown in FIG. 5 may be identifiable by SIP event server 14 as being an SLP-based format. Accordingly, SIP event server may recognize this type of format and therefore send related messages (e.g., service registration, service discovery) only to service agents set up for SLP-based messages. In an optional embodiment, the format type may be identified by a repository/agent id. 49 within the SIP message having a value associated with a format for the payload, as shown in FIG. 6. As such, SIP event server 14 is able to identify the discovery protocol based on the state of identifier 49.

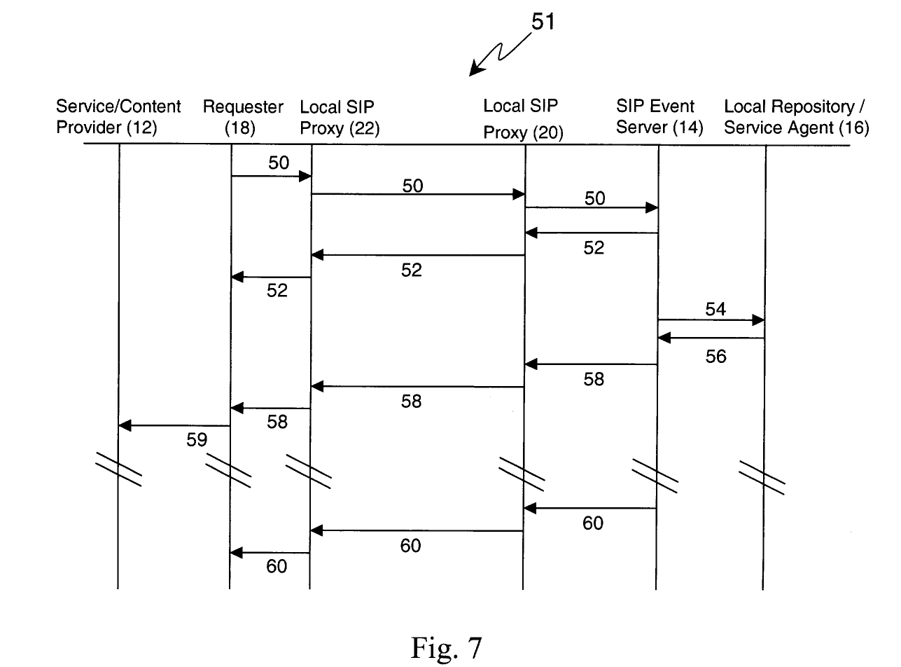

In other embodiments discussed further, upon reception of message 40, SIP event server 14 may compare the newly received service descriptions in message 40 with the existing subscriptions for the published/registered event, which is stored in database 35 of SIP event server 14. If a matching subscription is found, an appropriate notification is sent to the user associated with the subscription (see messaging associated with FIG. 7 and related discussion).

Referring back to FIG. 4, local repository/service agent 16 preferably sends a registration confirmation message 44 to SIP event server 14. However, the procedures related to service registration and discovery with local repository/service agent 16 depend on its particular requirements, which might not support registration confirmation. In a SIP environment, SIP event server 14 sends a Response message 46 to service provider 12, such as a ‘200 OK’ return code indicating a successful registration/publication. This message is forwarded appropriately back to service/content provider 12.

The same message sequence is used for de-registration of services. In such a scenario, the REGISTER or PUBLISH message 40 contains appropriate information to indicate the de-registration of the contained service specification. Message 42 may be appropriately adapted to de-register the service from the local repository/service agent 16. Further, the local database 35 in memory 34 of SIP event server 14 is checked, similar to the registration case, for matching subscription for the de-registered event, and appropriate notifications are sent as shown in FIG. 7 and discussed below.

Note that it is also possible to register services and/or content according to other embodiments without using the above mentioned SIP methods. Suppose as an example that registration is based on another method, such as SLP messaging. Accordingly, upon reception of the corresponding SLP registration message, the SIP event server 14 proceeds as if message 40 of method 43 shown in FIG. 4 had been received. For example, SIP event server 14 proceeds to send service registration message 42 to the local repository/service agent 16.

Referring now to FIG. 7 in particular, as well as FIGS. 1-3 in general, message flows for a service and/or content subscription/notification method 51 according to another embodiment of the present invention are shown. According to method 51, requester 18 may subscribe to notifications for particular events. As such, requester 18 receives notifications related to subscribed-to events at periodic intervals, such as at pre-defined intervals or when the status changes for subscribed-to events. For instance, returning to the company/teleconference scenario of FIG. 4, suppose that requester 18 is a mobile device. Suppose further that mobile device 18 is registered with a remote SIP proxy (not shown) while the user is traveling in his car and suppose that the user receives an IP-phone call while traveling in his car. Suppose also that the call contains video information, but that the video is not displayed due to lack of video output capabilities on mobile device 18. Suppose further that when the user arrives at his company, the call is handed over to the company's private network by applying known mobile IP techniques.

In order to locate an available IP-enabled display device to complete his call, the user may subscribe to SIP event server 14 for notifications of a service event for available IP-enabled display devices. Accordingly, when registering with the company's private network, mobile device 18 obtains the address of SIP event server 14 that communicates with local repositories/service agents throughout the company. In particular, SIP event server 14 communicates with local repository/service agent 16, which supports devices within the user's physical location within the company network. In order to locate an IP-enabled display device, mobile device 18 sends a SUBSCRIBE message 50 to its corresponding local SIP proxy 22, which contains as a payload the description of the desired service (e.g. IP-enabled display service) and the event of interest, for example registered/published or de-registered. SUBSCRIBE message 50 may contain an “expires” parameter (not shown) indicating duration of the subscription. Depending on the length of the subscription, mobile device 18 may receive periodic notifications in response to changes for the event or may receive a one-time notification of available IP-enabled displays for his location.

SUBSCRIBE message 50 according to this embodiment may be a message that is part of an extension to SIP as defined in IETF's RFC 3265 entitled “SIP-Specific Event Notification,” dated June 2002. The format of the service description in the payload may include, for example, attribute-based formats such as used in SLP or RDF-based formats or a dedicated format for SIP service description. SUBSCRIBE message 50 is appropriately forwarded to the SIP event server 14 via proxies 22 and 20. Upon reception of SUBSCRIBE message 50, SIP event server 14 stores the subscription for the specified event (e.g., published/registered, de-registered) in local database 35 stored in memory 34 (shown in FIG. 3). The associated description and the expiration time for the subscription are also stored in local database 35.

Upon reception of SUBSCRIBE message 50, SIP event server 14 appropriately confirms reception with a ‘200 OK’ message 52 sent to the requester via proxies 20 and 22. If requester 12 subscribed for a published/registered event, SIP event server 14 further sends a service discovery message 54 to the associated local repository/service agent 16 to perform a match with the service requested. Note that an appropriate mapping might be necessary from the input representation of the service description given in SUBSCRIBE message 50 to the required service description of the local repository 16. This may be particularly true if the repository 16 represents a service discovery agent of a particular format (e.g., SLP, RDP). In the presence of several associated repositories (not shown), message 50 may include an appropriate identifier (not shown) to decide which one of the associated repositories is to be used. This can be done explicitly as discussed with FIG. 6 above for REGISTER message 40. It may further be accomplished implicitly via SIP event server 14 recognizing the payload format and making the decision based on the recognized format.

In an alternate embodiment, SIP event server 14 may discover the service/content requested with all local repositories having the identified or recognized format by sending service discovery messages 54 to all associated local repositories/service agents. For that, an appropriate mapping of the service description format might be necessary as outlined above. If the repository functionality is co-located with the SIP event server 14, message 54 might not need to be sent. Local repository/service agent 16 subsequently sends a service discovery response message 56 to SIP event server 14 describing devices that meet the requested requirements. The format of the response message 56 may be an attribute-based format such as used in SLP or RDF-based formats. In addition, a dedicated SIP service description format may be used, which might require standardization in appropriate standardization bodies, such as IETF.

If several requests have been sent to several associated repositories/agents 16, SIP event server 14 waits for responses from all these agents. Note that an appropriate mapping of the service description format used by local repositories/service discovery agents 16 onto the used service description format may be required. For example, attribute-based formats such as used in SLP or RDF-based formats may be used, as may a dedicated format for SIP service description.

Upon reception of all repository responses 56, SIP event server 14 sends a NOTIFY message 58 back to requester 18 via proxies 20 and 22. This message contains the description of found services and the triggered event (in this case registered/published) in an appropriate format. It further contains the contact URI(s) provided in the service registration(s) of the service provider(s), such as service/content provider 12. If there has been no match for the requested services/content, the payload contains an appropriate indication. The NOTIFY message 58 is appropriately routed through the SIP proxies 20, 22 to requester 18. Upon reception of NOTIFY message 58, a respective application (not shown) on requester 18 extracts the received service descriptions and the contact URI for further use, if available. For instance, requester 18 may subsequently contact service provider 12 using a SIP INVITE message.

Note that the invention allows for a one-time discovery request/response scheme, which may be referred to as a QUERY. For a QUERY, requester 18 sends a SUBSCRIBE message 50 for a published/registered event in which an expiration time of zero is specified for the subscription. As such, the subscription is not stored in the local database of SIP event server 14. Thus, only the service lookup with local repository/service agent 16 is performed, leading to an appropriate NOTIFY message 58 that is sent to requester 18.

If the subscription in message 50 has not been a one-shot subscription, i.e., a non-zero expiration time has been given in message 50, SIP event server 14 has to perform appropriate matching functions upon reception of new service registrations or de-registrations, as outlined above. Hence, if a new service registration or de-registration is received, SIP event server 14 compares the service characteristics with the stored subscriptions for the appropriate event (i.e., registered/published for service registrations and de-registered for service de-registrations), and generates appropriate NOTIFY messages 60 that are sent to subscribed requesters 18. These messages are appropriately routed through the SIP proxies 20, 22 to requester 18, therefore notifying requester 18 of available or de-registered services that met the given characteristics of the subscription. Accordingly, requester application (not shown) extracts the received service descriptions and the contact URI for further use, if available, for instance to contact service provider 12. If a stored subscription with SIP event server 14 expires, SIP event server 14 may remove the appropriate subscription from its local database (not shown).

In the present example, suppose local repository/service agent 16 determines that service provider 12 meets the video display requirements for the ongoing IP-based phone call as requested. As such, local repository/service agent 16 returns the URL for display unit 12 in response message 56. SIP event server 14 in turn sends a NOTIFY message 58 to mobile device 18 describing all found services that meet desired service requirements, which in this example includes display unit 12. Upon reception of the NOTIFY message 58, mobile device 18 extracts received service descriptions, which in this example include the URL for display device 12. Mobile device 18 can now initiate the transfer of the video information from the caller to the IP display device 12 by sending a SIP INVITE message 59 to the IP-enabled display device 12.

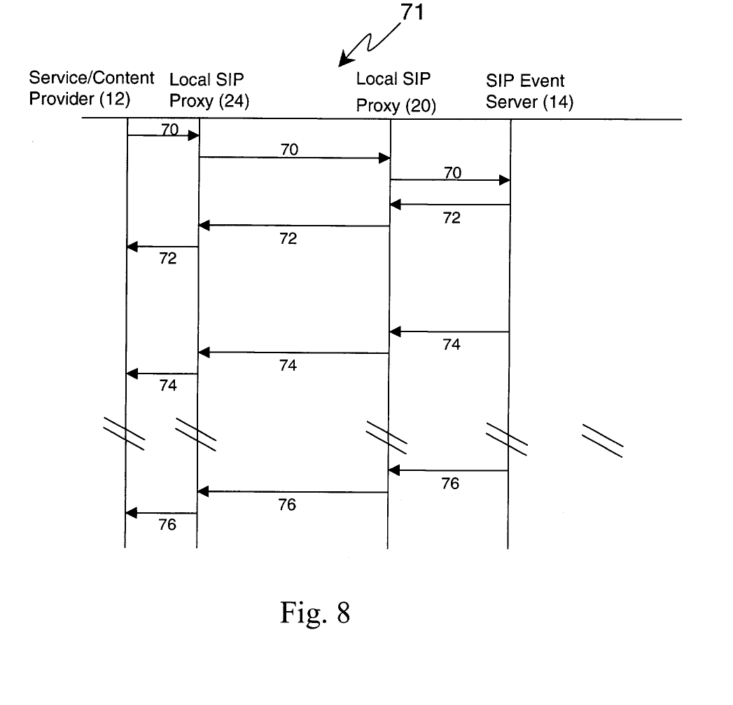

Referring now to FIG. 8 in particular, as well as FIGS. 1-3 in general, message flows for a service and/or content subscription/notification of service requests method 71 according to further embodiment of the present invention are shown. Method 71 generally contains the same aspects and preferences as method 51, except as with regard to subscription of service and/or content requests. According to method 71, service/content provider 12 may subscribe to service requests that have been published by requesters, such as requester 18. As such, service/content provider 12 receives notifications related to subscribed-to events at periodic intervals, such as at pre-defined intervals or when the status changes for subscribed-to events.

For instance, returning to the company/teleconference scenario of FIGS. 4 and 7, suppose that service/content provider 12 (IP-enabled display) has subscribed to a “requested” event for IP-display service requests. As such, when mobile device 18 subscribes to an event for IP-display services, IP-enabled display 12 will automatically be notified of such service request. IP-enabled display 12 may therefore choose to contact requester 18 directly, or may prepare itself for providing such a service.

As shown in FIG. 8, service/content provider 12 sends a SUBSCRIBE message 70 for the appropriate event, i.e., “requested” or “request_removed,” to SIP event server 14 via SIP proxies 24, 20. As with the previous embodiment, SUBSCRIBE message 70 contains the service and/or content information to which service/content provider 12 subscribes as a message body. As discussed with the previous embodiment, SIP event server 14 responds with a return code message 72, e.g., ‘200 OK’, to the service/content provider 12 sent via SIP proxies 20, 24.

Upon reception of SUBSCRIBE message 70, for a requested event, SIP event server 14 checks its local subscription database 35 for matching entries. If there are any matching entries, it returns such information to service/content provider 12 in the message body of a NOTIFY message 74, which is forwarded to the service/content provider via SIP proxies 20, 24. For a request_removed event, the SIP event server 14 simply responds with a NOTIFY message 74 that contains an empty message body, because there will not have been any removals yet. For both events, the event server stores the subscription in its local database 35 for further notifications.

If there are any incoming service discovery requests from a requester 18, such as according to method 51, or if there are any removals of subscriptions to those events, SIP event server 14 checks those incoming subscriptions against the subscriptions for the requested or request_removed events and generates appropriate NOTIFY messages 76. Subsequent NOTIFY messages 76 are sent to the appropriate service/content provider(s) that subscribed to those events. The message body of those notifications contains information about the content and/or service(s) requested and the requester(s) identification (e.g., URIs).

The present invention is fully applicable to a wide range of services and content, as well as to other types of discoverable information. As an additional example, suppose SIP event server 14 serves a network for a large shopping mall. Suppose many of the stores and merchants associated with the mall maintain various service/content providers 12. For instance, movie theaters may maintain servers that provide content related to movie schedules, prices, movie trailers, etc. In addition, retail stores may maintain servers that provide content related to store specials, coupons, etc. Further, service kiosks may provide services, such as printing services, computing or teleconferencing services.

Each of these entities may register their servers and devices with one or more local repositories 16, which may operate with specific discovery protocols. Many of these entities may also subscribe to events with SIP event server 14. For example, a service kiosk may use a computer to subscribe to multiple service request events, and as such may receive notifications whenever requesters request certain services, such as printing, computing, or teleconferencing services. Under such a scenario, a user of a mobile device 18 may request a wide variety of content and/or services to enhance their shopping experience. From the perspective of the mobile device user, content and services may easily be discovered using SIP messaging regardless of particular discovery protocols used by the repositories 16.

While the present invention has been described in connection with the illustrated embodiments, it will appreciated and understood that modifications may be made without departing from the true spirit and scope of the invention. In particular, the invention applies to other session related protocols, to various discovery mechanisms and protocols, and to a variety of different devices and networks. Further, the present invention is applicable to a wide range of services and content, as well as to other types of discoverable information.

I claim:

1. A method of registering or de-registering service and/or content capabilities of a provider with a network entity, said method comprising:
creating a register message comprising:
an event package description describing an event package comprising one of a service event package and a content event package;
an event type description describing an event type comprising one of a register event type and a de-register event type; and
one of service and content capability information for said provider; and
sending said register message to said network entity.

2. The method of claim 1, further comprising the step of receiving a confirmation message from said network entity.

3. The method of claim 1, wherein for said step of sending, said network entity comprises an event server.

4. The method of claim 1, wherein for said steps of creating and sending, said event server comprises a SIP event server and said register message comprises one of a session initiation protocol (SIP) REGISTER message and a SIP PUBLISH message.

5. The method of claim 1, wherein for said steps of creating and sending, said register message further comprises a uniform resource identifier (URI) for said provider.

6. The method of claim 1, wherein for said steps of creating and sending, said one of service and content capability information comprises information having an attribute-based format.

7. The method of claim 6, wherein said attribute-based format is selected from the group consisting of service location protocol (SLP) and Resource Description Framework (RDF).

8. The method of claim 1, wherein for said step of sending, said network entity is in communication with a discovery agent associated with a repository, and said register message comprises an identifier identifying one of said discovery agent and said repository.

9. A method of registering or de-registering service and/or content capabilities of a provider with a repository, said method comprising the steps of: receiving a register message at a network entity, said register message comprising an event package description describing an event package comprising one of a service event package and a content event package, an event type description describing an event type, and one of service and content capability information for said provider; and
sending a registration/de-registration message for said provider to said repository.

10. The method of claim 9, further comprising sending a confirmation message to said provider.

11. The method of claim 9, wherein for said step of sending, said repository is in communication with a discovery agent, and for said step of receiving, said register message comprises an identifier identifying one of said repository and said discovery agent.

12. The method of claim 11 further comprising the steps of:
detecting said identifier; and
choosing one of said repository and said discovery agent based on said identifier.

13. The method of claim 9, further comprising the steps of:
recognizing a format of said one of said service and content capability information; and
selecting said repository based on said recognized format.

14. The method of claim 9, wherein for said step of receiving, said network entity comprises a SIP event server.

15. A method for subscribing with an event server to an event maintained by the event server, said event associated with services and/or content available within a network, said method comprising:
receiving at said event server from a first network entity a subscription message subscribing to said event, said message having an event package description describing an event package comprising one of a service event package and a content event package, an event type description describing an event type corresponding to said event package, and a description for one of a service and a content requested;
checking for a match for said event package, said corresponding event type, and said one of the service and content requested; and
sending a first notify message to said first network entity, said first notify message indicating whether said match was located.

16. The method of claim 15, wherein said first network entity comprises a requester and for said step of receiving said corresponding event type comprises one of a registered type and a published type.

17. The method of claim 16, wherein said step of checking for a match comprises:
sending a discovery message to a repository, said discovery message requesting information about providers matching said one of the service and content requested; and
receiving a discovery response from said repository, said discovery response generated in response to said repository checking for a match for said one of the service and content requested, said discovery response containing one of an indication of a non-existing match and at least one provider substantially matching saidone of service and content requested.

18. The method of claim 16, said method further comprising:
receiving a register message from a provider, said register message comprising an event package description describing an event package comprising one of a service event package and a content event package, an event type description describing one of a register event type and a de-register event type, and one of service and content capability for said provider;
checking for a service/content match of said one of the service and the content capability information for said provider; and
on condition said service/content match is located, and on condition said service/content match includes a substantial match with said one of the service and the content requested by said requester, notifying said requester of said register message from said provider.

19. The method of claim 15, wherein for said step of receiving a subscription message, said subscription message comprises an expiration time for expiration of the subscription to said event, said method further comprising:
receiving a register message from a second network entity, said register message comprising one of service and content capability information for said second network entity substantially matching said one of the service and content requested from said first network entity; and
on condition said expiration time has not expired, sending a second notify message notifying said first network entity of said match with said one of the service and content capability information for said first network entity.

20. The method of claim 15, wherein said first network entity comprises a requester and for said step of receiving, said corresponding event type comprises a de-registered type, said method further comprising:
receiving a register message from a provider, said register message comprising one of service and content capability information for said provider and an event type description describing a de-register event type, said service and content capability information for said provider matching said service and content requested for said requester;
checking for a service/content match of said one of service and content capability information for said provider; and
on condition said service/content match is located, notifying said requester of the de-registered state of said provider.

21. The method of claim 20, wherein for said step of checking for a service/content match, said event server compares said service and content capability information for said provider with a subscription database.

22. The method of claim 15, wherein said first network entity comprises a provider and for said step of receiving, said corresponding event type comprises a requested type.

23. The method of claim 22, said method further comprising:
receiving a subscription message from a requester, said subscription message comprising an event package description describing an event package comprising one of a service event package and a content event package, an event type description describing one of a registered event type and a published event type, and a description for one of a service and a content requested;
checking for a service/content match of said one of the service and the content requested by said requester; and
on condition said service/content match is located, and on condition said service/content match includes a substantial match with said one of the service and the content requested by said provider, notifying said provider of said subscription message from said requester.

24. The method of claim 15, wherein said first network entity comprises a provider and for said step of receiving, said corresponding event type comprises a request type, said method further comprising:
receiving a second subscription message from a requester requesting removal of a first subscription request requesting said one of the service resource and the content resource;
checking for a service/content match of said one of the service and the content requested in the first request by said requester; and
on condition said service/content match is located, and on condition said service/content match includes a substantial match with said one of the service and the content requested by said provider, notifying said provider of said subscription removal message from said requester.

25. The method of claim 15, wherein for the step of receiving, said event server comprises a SIP event server and said subscription message comprises a SIP SUBSCRIBE message.

26. The method of claim 25, wherein said step of notifying comprises the step of sending a SIP NOTIFY message.

27. The method of claim 15, wherein said description for one of the service and content requested comprises information having an attribute-based format.

28. The method of claim 27, wherein said attribute-based format is selected from the group consisting of SLP and RDF.

29. A computer-readable medium having computer-readable instructions for performing steps for registering or de-registering service and/or content capabilities of a provider with a repository, said steps comprising:
receiving a register message at a network entity, said register message comprising an event package description describing an event package comprising one of a service event package and a content event package, an event type description describing an event type, and one of service and content capability information for said provider; and
sending a registration/de-registration message for said provider to said repository.

30. The computer-readable medium of claim 29, wherein for said step of receiving, said network entity comprises a SIP event server.

31. A computer-readable medium having computer-readable instructions for performing steps for subscribing with an event server to an event maintained by the event server, said event associated with services and/or content available within a network, said steps comprising:
receiving at said event server a subscription message subscribing to said event from a first network entity, said message having an event package description describing an event package comprising one of a service event package and a content event package, an event type description describing an event type corresponding to said event package, and a description for one of a service and a content requested;
checking for a match for said event package, said corresponding event type, and said one of the service and content requested; and
sending a first notify message to said first network entity, said first notify message indicating whether said match was located.

32. A device comprising:
a memory containing instructions for registering service and/or content capabilities of the device with a repository; and
a processor for performing steps according to said instructions stored in said memory, said steps comprising:
creating a register message comprising:
an event package description describing an event package comprising one of a service event package and a content event package;
an event type description describing an event type comprising one of a register event type and a de-register event type; and
one of service and content capability information for said provider; and
sending said register message to an event server.

33. An event server comprising:
a memory containing instructions for registering service and/or content capabilities of a provider with a repository; and
a processor performing steps according to said instructions stored in said memory, said steps comprising:
receiving a register message comprising an event package description describing an event package comprising one of a service event package and a content event package, an event type description describing an event type, and one of service and content capability information for a provider; and
sending a registration/de-registration message for said provider to said repository.

34. An event server comprising:
a memory containing instructions for maintaining a subscription to an event, said event associated with services and/or content available within a network; and
a processor performing steps according to said instructions stored in said memory, said steps comprising:
receiving from a network entity a subscription message subscribing to said event, said message having an event package description describing an event package comprising one of a service event package and a content event package, an event type description describing an event type corresponding to said event package, and a description for one of a service and a content requested;
checking for a match for said event package, said corresponding event type, and said one of the service and content requested; and
sending a notify message to said network entity, said notify message indicating whether said match was located.

35. A event server comprising:
a memory containing instructions for registering service and/or content capabilities of a provider and maintaining a subscription to a registered event; and
a processor for performing steps according to said instructions stored in said memory, said steps comprising:
receiving from a provider a register message comprising an event package description describing an event package comprising one of a service event package and a content event package, an event type description describing a register event type, and one of service and content capability information for said provider;
receiving from a requester a subscription message subscribing to an event, said subscription message having an event package comprising said event package of said register message, an event type description comprising a registered type, and a description for one of a service and a content requested substantially matching said one of service and content capability of said provider;
checking for a substantial match for said requester event package;
locating said substantial match with said provider event package; and
notifying said provider of said match.
